(19) United States
(12) Patent Application Publication
(10) Pub. No.: US 2010/0117366 A1
(43) Pub. Date: May 13, 2010

(54) METHODS AND APPARATUS FOR POWER GENERATION

(76) Inventors: Kenneth Rhinefrank, Corvallis, OR (US); Annette Von Jouanne, Corvallis, OR (US); Joseph Prudell, Corvallis, OR (US); Alphomse Schacher, Corvallis, OR (US); Alexandre F Yokochi, Corvallis, OR (US); Ted Brekken, Corvallis, OR (US); David Elwood, Corvallis, OR (US); Chad Stillinger, Corvallis, OR (US); Robert K. Paasch, Corvallis, OR (US)

Correspondence Address: KLARQUIST SPARKMAN, LLP, 121 SW SALMON STREET, SUITE 1600, PORTLAND, OR, 97204, US

(21) Appl. No.: 12/529,178

(22) PCT Filed: Mar. 3, 2008
(86) PCT No.: PCT/US08/02837

§ 371 Date: Aug. 28, 2009

Related U.S. Application Data
(60) Provisional application No. 60/904,695, filed on Mar. 2, 2007.
(60) Provisional application No. 60/918,352, filed on Mar. 16, 2007.

(51) Int. Cl. F03B 13/18; H02K 19/22

(52) U.S. Cl. 290/53; 310/12.12

(57) ABSTRACT

An ocean wave energy converter system comprises an armature and a plurality of magnets which move relative to each other in response to ocean waves pushing on a spar and/or float to which the armature and the plurality of magnets are coupled. Components of the system comprise stacked rings and/or radial laminations. The armature can feature a variety of pole tips. Various methods can be used to assemble components from radial laminations. Air gaps in wire coils of the armatures can be filled with one or more materials that selectively alter the magnetic permeability of the wire coils.

### CROSS-REFERENCE TO RELATED APPLICATIONS

This application claims the benefit of U.S. Provisional Patent Application No. 60/904,695, titled “Methods and Apparatus for Power Generation,” filed Mar. 2, 2007, and U.S. Provisional Patent Application No. 60/918,352, titled “Methods and Apparatus for Power Generation,” filed Mar. 16, 2007, both of which are incorporated herein by reference.

### ACKNOWLEDGMENT OF GOVERNMENT SUPPORT

This invention was made with government support under: contract number DE-FG02-05-ER86257, awarded by the Department of Energy; award number 0300386, awarded by the National Science Foundation; award number NA16RG1039, awarded by the National Oceanic and Atmospheric Administration; and contract number N62473-07-C-4069, awarded by the Department of the Navy. The government has certain rights in the invention.

### FIELD

The disclosed technologies relate to power generation from wave energy.

### BACKGROUND

Ocean waves are a potential source of energy, for example, for generating electricity. Commonly proposed energy extraction techniques are often based on hydraulic or pneumatic intermediaries that can require high maintenance costs and are often prone to failure. Under operating conditions such as heavy seas, the intermediaries can be damaged by excessive force of the waves. Additionally, at least some devices are relatively expensive to manufacture.

### SUMMARY

An ocean wave energy converter system comprises an armature and a plurality of magnets which move relative to each other in response to ocean waves pushing on a spar and/or float to which the armature and the plurality of magnets are coupled. Components of the system comprise stacked rings and/or radial laminations. The armature can feature a variety of pole tips (also called “shoes”). Various methods can be used to assemble components from radial laminations. Air gaps in wire coils of the armatures can be filled with one or more materials that selectively alter the magnetic permeability of the wire coils.

In some embodiments, an apparatus for converting wave motion to electrical power, wherein the system is at least partially immersed in a liquid through which the waves travel, the apparatus comprises: a first component having an overall buoyancy relative to the liquid so as to float in the liquid; a second component movably coupled to the first component, wherein the second component is configured to move relative to the first component in a direction of motion in response to a force from waves that is exerted on the first component; and an electrical generator coupled to the first and second components, the electrical generator comprising an armature and a magnet housing, wherein at least one of the armature and the magnet housing comprises a plurality of laminations that can have major surfaces oriented in the direction of motion. In further embodiments, the armature comprises the plurality of laminations that can have major surfaces oriented generally in the direction of motion. The plurality of laminations can form a plurality of vertically spaced apart projections extending toward the magnet housing, the projections comprising distal and proximate end portions, the distal end portions having distal end surfaces spaced by a gap from the magnet housing, the armature also comprising a backing portion interconnecting proximate end portions of the projections, wherein magnetic flux paths are provided through the distal end portions of the projections and backing portion, the projections defining electrically conductive wire receiving pockets therebetween, and electrical wires positioned at least partially within the wire receiving pockets and coupled to at least one power output. In some embodiments, at least a plurality of the distal ends of the projections are enlarged to increase a volume of said distal end portions and wherein at least a portion of the distal end surface of at least a plurality of distal end portions has a curvature. In further embodiments, at least a plurality of the distal ends of the projections are enlarged to increase a volume of said distal end portions and wherein at least a portion of the distal end surface of at least a plurality of distal end portions is convex. In additional embodiments at least plurality of the distal ends of the projections are enlarged to increase a volume of said distal end portions and wherein at least a plurality of the distal end surfaces comprise a flat central portion parallel to the direction of travel of the magnet housing and a curved peripheral portion.

In some cases the plurality of laminations comprising the armature are configured in a plurality of rings stacked generally in the direction of motion. In further cases the plurality of laminations comprising the armature extend in a radial direction and together define an opening through which the magnet housing is inserted. Also, the plurality of laminations comprising the armature can extend in a radial direction and together define a circumference around which the magnet housing is placed. In further embodiments a fill material is positioned between first and second laminations of the plurality of laminations. In additional embodiments at least some of the plurality of laminations are coupled to a component providing one or more apertures for receiving wires in the armature or magnet housing. In some embodiments at least one of the laminations in the plurality of laminations has a non-uniform thickness. For example, at least one of the laminations in the plurality of laminations has a thickness that increases as the lamination extends radially outward.

In further embodiments, the plurality of laminations form a plurality of ring segments. In particular embodiments, the magnet housing comprises at least one magnet and at least some of the plurality of laminations that can have major surfaces oriented generally in the direction of motion. At least some of the plurality of laminations comprising the magnet housing can comprise a T-shaped groove.

In some embodiments, a heat exchanger is configured to remove heat from the armature. Sometimes one or more coolant passageways are coupled to the heat exchanger.

In additional embodiments, an apparatus for converting wave motion to electrical power, wherein the system is at least partially immersed in a liquid through which the waves travel, comprises: a first component having an overall buoyancy relative to the liquid so as to float in the liquid; a second component movably coupled to the first component, wherein the second component is configured to move relative to the first component in a direction of motion in response to a force from waves that is exerted on the first component; and an electrical generator coupled to the first and second components, the electrical generator comprising an armature and a translator, wherein the armature comprises one or more coils, the coils comprising electrically conductive wires with one or more ferrous materials positioned between the wires. In some cases at least a portion of the electrically conductive wires have a round, oval or polygonal cross-section. Sometimes the electrically conductive wires with one or more ferrous materials positioned between the wires comprise one or more wires coated with the one or more ferrous materials before being wound into the coils. Sometimes the electrically conductive wires with one or more ferrous materials positioned between the wires comprise one or more wires wound into the coils with one or more cords comprised of the ferrous materials. In further embodiments the one or more ferrous materials positioned between the wires comprise a plurality of particles oriented in a preferred magnetic flux direction of the particles.

In some embodiments a method of making a component for a wave generator armature comprises: winding one or more conductive wires around a support; and filling a gap between at least portions of the one or more wires with one or more materials having a selected magnetic property and comprising a plurality of magnetic particles. In further embodiments filling the gap between the one or more wires with one or more materials having the selected magnetic property comprises coating at least a portion of the one or more wires with the materials having the selected magnetic property. In additional embodiments filling the gap between the one or more wires with one or more materials having the selected magnetic property further comprises heating the wound one or more conductive wires. Sometimes the one or more conductive wires are wound around the support such that the gap is a predetermined gap. Also, filling the gap between the one or more wires with one or more materials having the selected magnetic property can comprise vacuum filling the gap. Sometimes the support is a bobbin and/or a portion of the armature. Sometimes the method further comprises orienting at least some of the magnetic particles using a magnetic field. In some cases filling the gap between at least portions of the one or more wires with one or more materials having the selected magnetic property and comprising the plurality of magnetic particles comprises providing the one or more materials to the gap using a wicking material positioned in the gap.

In further embodiments an apparatus for converting wave motion to electrical power, wherein the system is at least partially immersed in a liquid through which the waves travel, comprises: a first component having an overall buoyancy relative to the liquid so as to float in the liquid; a second component movably coupled to the first component, wherein the second component is configured to move relative to the first component in a direction of motion in response to a force from waves that is exerted on the first component; and an electrical generator coupled to the first and second components, the electrical generator comprising at least one component molded from a resin comprising a plurality of magnetic particles.

### BRIEF DESCRIPTION OF THE DRAWINGS

FIGS. 1A and 1B show views of one embodiment of an ocean wave energy converter system.

FIG. 2 shows a vertical sectional view of one embodiment of an ocean wave energy converter system.

FIG. 3 shows a vertical sectional view of another embodiment of an ocean wave energy converter system.

FIG. 4 shows a vertical sectional view of yet another embodiment of an ocean wave energy converter system

FIG. 5 shows a vertical sectional view of the float of the embodiment of FIG. 4.

FIG. 6 shows an embodiment of an exemplary magnet compartment of FIGS. 4 and 5.

FIG. 7 shows a vertical sectional view of an embodiment of a magnet compartment and an armature that can be used, for example, in the embodiments of FIGS. 4 and 5.

FIG. 8 is an enlarged view of a portion of the embodiment of FIG. 7.

FIG. 9 is an enlarged view of an alternative embodiment of a portion similar to that shown in FIG. 8.

FIGS. 10-14 show cross-sectional views of various exemplary embodiments of teeth tips that can be used with armature embodiments described herein.

FIG. 15 shows a vertical sectional view of an exemplary embodiment of two adjacent armature ring sections.

FIG. 16 shows a top plan view of an exemplary embodiment of an armature ring section.

FIG. 17A shows a top plan view of an exemplary embodiment of a plurality of radial laminations.

FIG. 17B shows a side view of an exemplary embodiment of a wire exit guide.

FIG. 17C shows a perspective view of a wire exit guide.

FIG. 18 shows a perspective view of a portion of one embodiment of the radial laminations of the embodiment of FIG. 17A.

FIGS. 19-24 show vertical sectional views of various alternative embodiments of the radial laminations of FIG. 17A.

FIG. 25 shows a vertical sectional view of an embodiment of an armature component.

FIG. 26 shows a vertical sectional view of an embodiment comprising stacked armature components.

FIG. 27 shows a side elevational view of an alternative embodiment comprising radial laminations.

FIG. 28 is a vertical sectional view of an embodiment comprising a plurality of laminations held in place by compression rings.

FIG. 29 shows a plan view of an exemplary embodiment of a holder configured to receive laminations.

FIG. 30 shows an embodiment of a radial lamination for constructing an exemplary armature.

FIG. 31 shows an embodiment of a lamination for constructing an exemplary backiron section.

FIG. 32 shows a perspective view of an embodiment of an exemplary magnet housing component.

FIG. 33 shows a perspective view of one embodiment of a bobbin.

FIG. 34 shows a flowchart of an exemplary embodiment of a method for filling air voids in a wire coil.

FIG. 35 shows embodiments of exemplary cross-sections of wires that can be used in making a relatively low air gap coil.

FIGS. 36A-36C depict an exemplary embodiment of an ocean wave energy converter system.

FIG. 37 shows a vertical sectional view of an exemplary embodiment of an armature and a field.

FIG. 38 shows a close-up vertical sectional view of an exemplary embodiment of a wire coil in FIG. 37.

FIG. 39 shows a cross-sectional view of an exemplary embodiment of a wire encased at least in part by a fill portion designed to provide a square cross-section.

FIG. 40 shows a cross-sectional view of an exemplary embodiment of a wire coil.

FIG. 41 shows a perspective view of a slice of the wire coil of FIG. 40.

FIG. 42 shows a cross-sectional view of an exemplary embodiment of a wire wrapped in a plurality of fill threads.

FIG. 43 shows a cross-sectional view of an exemplary embodiment of a wire coil.

### DETAILED DESCRIPTION

Disclosed below are embodiments of wave power generation system technologies and/or related technologies. The embodiments should not be construed as limiting in any way. Instead, the present disclosure is directed toward all novel and nonobvious features and aspects of the various disclosed methods, apparatus, and equivalents thereof, alone and in various combinations and subcombinations with one another. The disclosed technologies are not limited to any specific aspect or feature, or combination thereof, nor do the disclosed methods and apparatus require that any one or more specific advantages be present or problems be solved.

As used in this application and in the claims, the singular forms “a,” “an” and “the” include the plural forms unless the context clearly dictates otherwise. Additionally, the term “includes” means “comprises.” The phrase “and/or” can mean “and,” “or” and “one or more of” the elements described in the sentence. Moreover, unless the context dictates otherwise, the term “coupled” means physically connected or electrically or electromagnetically connected or linked and includes both direct connections or direct links and indirect connections or indirect links through one or more intermediate elements. Embodiments described herein are exemplary embodiments of the disclosed technologies unless clearly stated otherwise.

Although the operations of some of the disclosed methods and apparatus are described in a particular, sequential order for convenient presentation, it should be understood that this manner of description encompasses rearrangement, unless a particular ordering is required by specific language set forth below. For example, operations described sequentially can in some cases be rearranged or performed concurrently. Moreover, for the sake of simplicity, the attached figures may not show the various ways in which the disclosed methods and apparatus can be used in conjunction with other methods and apparatus.

At least some technologies are described herein as applying to transverse flux power generators. However, unless explicitly stated otherwise, the technologies described herein also apply to longitudinal flux power generators. Also, unless explicitly stated otherwise, technologies described herein with respect to electric generators can also be applied to electric motors.

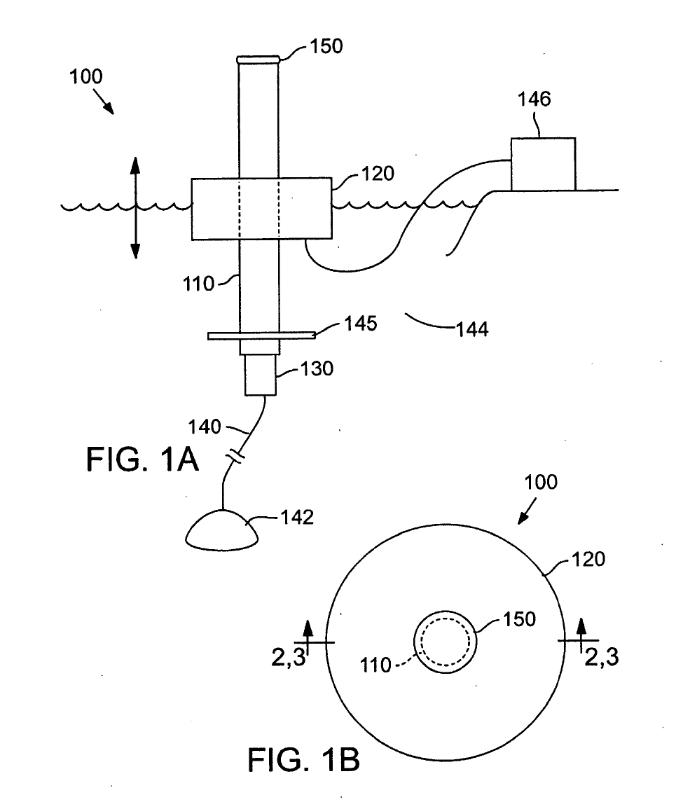

FIG. 1A shows a side view of one embodiment of a buoy generator system (i.e., an ocean wave energy converter system) 100. The buoy generator system 100 comprises an elongated spar 110 and a float 120. In various embodiments, spar 110 has a cross section that is round, square, or a number of other shapes, can be at least partially hollow, and can be constructed of a material that can withstand ocean conditions for a relatively long period of time, such as PVC or composite material. The float 120 is coupled to the spar 110 for movement relative to the spar. Desirably the float 120 encircles spar 110 at least in part (e.g., partially or entirely), and can be comprised of any number of buoyant materials. System 100 can further comprise a ballast weight 130 and a tether 140. FIG. 1A shows tether 140 as being connected to ballast weight 130, but it can also be connected to other parts of system 100, e.g., to spar 110. The remote end of tether 140 is connected to a mooring system 142, which can be any system or arrangement that allows the system 100 to maintain a relatively constant geographic position. For example, the mooring system could comprise a sea-floor mooring, a weight (such as an anchor) or pilings. A power output such as an electric cable 144 carries electricity from the system 100 to another location, e.g., a shore-based electric facility 146. The top end of spar 110 can be sealed by, for example, a cap 150 to protect its contents from the elements. Spar 110 is desirably configured such that it (with its contents) is approximately neutrally buoyant. System 100 can also comprise a wave deflector or wave motion resistor, such as a wave plate 145, which can be attached or coupled to spar 110, usually at a right angle to spar 110. However, wave plate 145 can also be attached at other angles. Wave plate 145 can provide a dampening force to improve a desirable relative linear motion of float 120 and spar 110. FIG. 1B shows a top view of the system 100.

Generally, generator system 100 can be moored offshore in an area where waves are common. As waves propagate past system 100, the waves move float 120 generally upwardly and downwardly relative to and along spar 110. System 100 converts at least some of the relative motion provided by the waves to electricity.

It should be noted that, although the motion of float 120 to spar 110 can be described and is often described in the application as “relative linear motion,” other types of relative motion can also be used. For example, if spar 110 is curved, float 120 can move along spar 110 in an arcuate motion. Relative linear sliding motion is a particularly desirable approach.

Cap 150 and plate 145 prevent total separation of float 120 and spar 110 in this example.

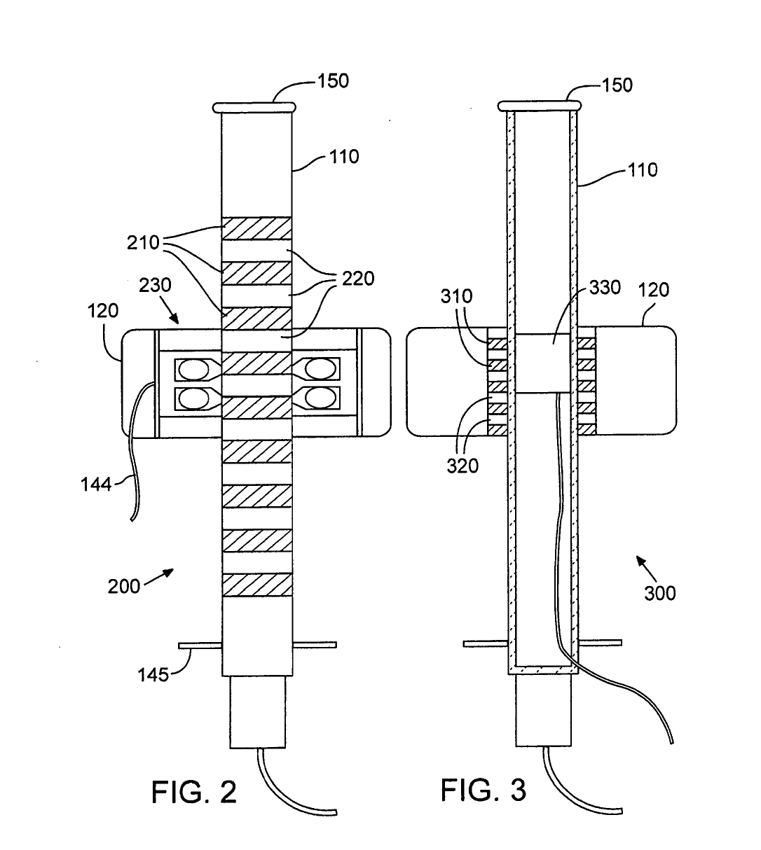

FIG. 2 shows a vertical sectional view of one embodiment 200 of an ocean wave energy converter system (also referred to herein as a “transverse flux power generator”), taken along the line 2-2 indicated in FIG. 1B. In this embodiment, the spar 120 comprises a translator (e.g., a field) with a plurality of magnets, such as magnets 210, interspersed with spacers 220, such as metal disks or supports. In some embodiments the magnets 210 comprise rare earth magnets, for example, NdFeB magnets (e.g., NdFeB-35, NdFeB-38H). The float 120 can comprise an armature 230, which is described in more detail below.

FIG. 3 shows a vertical sectional view of one embodiment 300 of an ocean wave energy converter system, taken along the line 3-3 indicated in FIG. 1A. In this embodiment, the float comprises a translator with one or more magnets (such as magnets 310) interspersed with one or more supports (e.g., metal plates or rings, such as rings 320). The spar 110 can comprise an armature 330, which, in some embodiments, is supported by one or more brackets (not shown) which fasten the armature 330 to the spar 110, or by other supports such as rods (not shown).

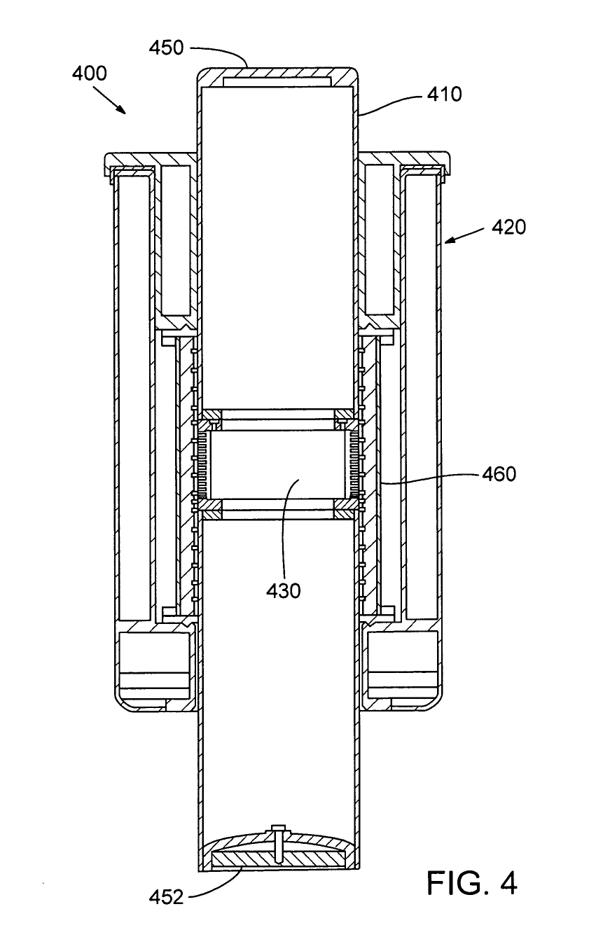

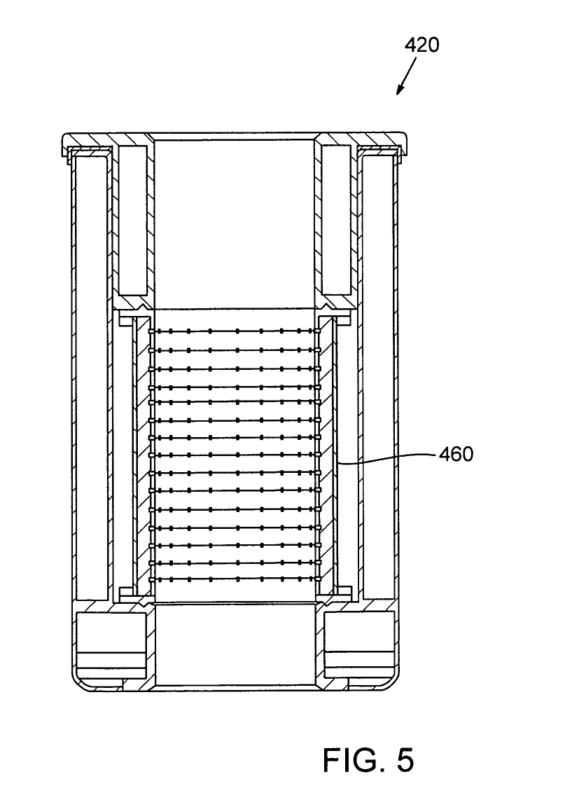

FIG. 4 shows a vertical sectional view of an additional embodiment 400 of an ocean wave energy converter system. In this embodiment, a float 420 comprises a magnet compartment 460 (an example of which is described in more detail below). The exemplary spar 410 comprises an armature 430 and upper and lower end caps 450, 452. FIG. 5 shows the float 420 without the spar 410.

Generally, in systems such as embodiments 100, 200, 300 and 400, as the float is moved up and down relative to the spar, an armature and magnets move relative to each other. As the armature moves through the magnetic fields, currents are generated in one or more wire coils of the armature.

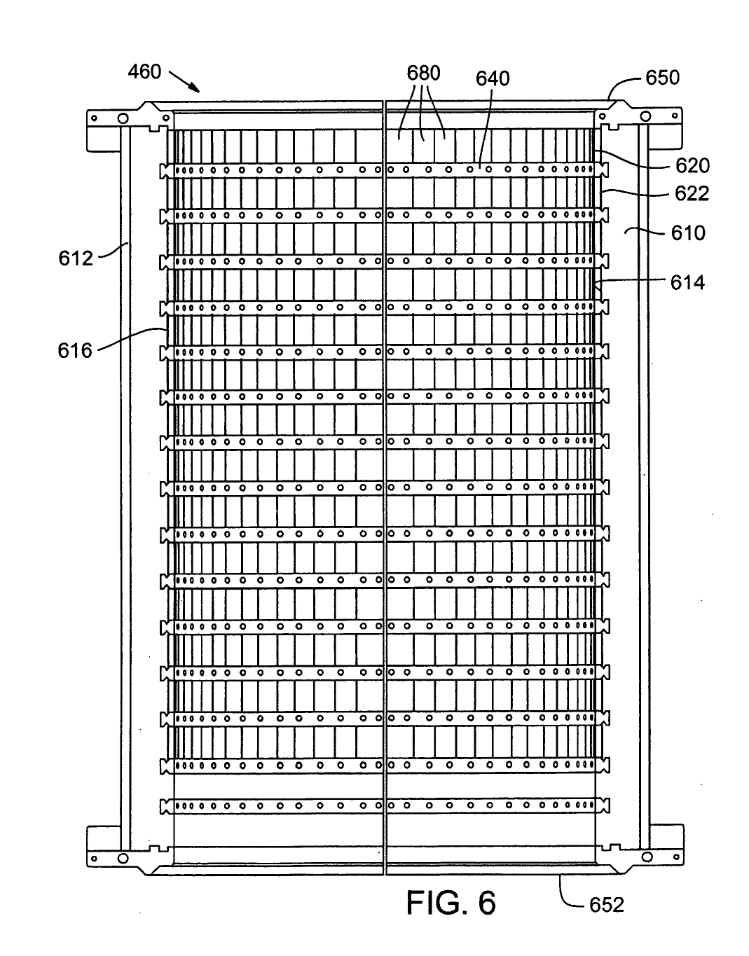

FIG. 6 shows the magnet compartment 460 of FIGS. 4 and 5 in more detail. The exemplary compartment 460 comprises backiron sections 610, 612. Respective inner surfaces 614, 616 of the backiron sections 610, 612 are, in this example, at least partially covered with one or more magnet rows or tiers, such as rows 620, 622. In the example of FIG. 6, the tiers are stacked vertically. Each magnet row 620, 622 in this example is annular and comprises one or more magnets such as magnets 630. In at least some embodiments, one or more of the magnets 630 are curved, e.g., in order to better fit against a curved backiron section. Generally, magnets in the rows 620, 622 are arranged such that adjacent rows have opposite magnetic polarities. For example, in some embodiments magnets of the row 620 are N-polarity, while magnets of the row 622 are S-polarity. In various embodiments, the magnets 630 can be held in place using one or more retainers 640 (made of aluminum, for example) and/or additional fastening devices (e.g., screws or rivets). In particular embodiments, one or more end retainers, such as ring portions 650, 652, can also be used to hold at least some magnets 630 in place.

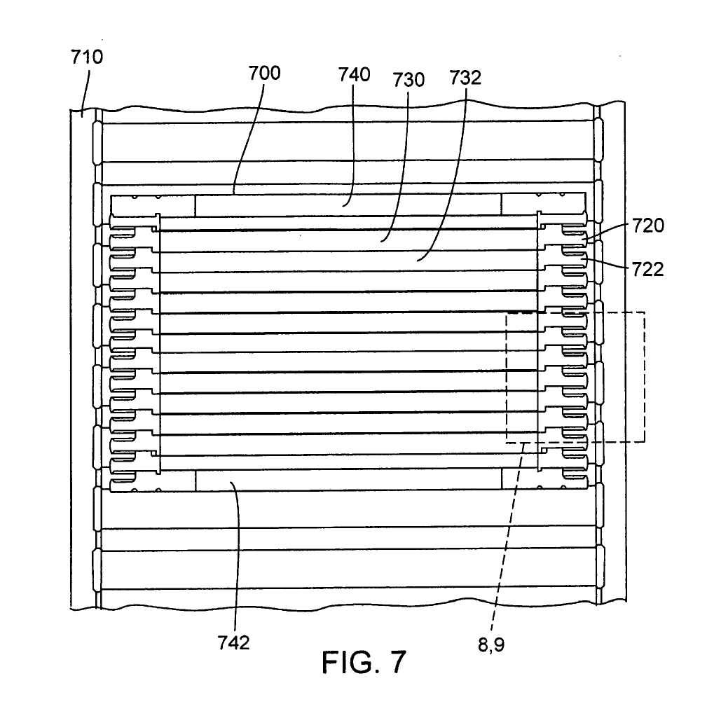

FIG. 7 shows a vertical sectional view of an armature 700 and a magnet compartment 710 that can be used with ocean wave energy converter systems described herein. The armature 700 comprises a plurality of teeth, such as teeth 720, 722. In various embodiments, wire coils can be positioned between teeth 720, 722, although such coils are not shown in FIG. 7. In various embodiments, the armature 700 comprises one or more ring sections, such as ring sections 730, 732. Plates 740, 742 can be used to compress the ring sections and reduce movement of the ring sections 730, 732 relative to one another. The plates 740, 742 can be interconnected and drawn together by bolts or other fasteners to compress the ring sections 730, 732 to provide mechanical and structural integrity. In some embodiments the plates 740, 742 can be comprised of non-magnetic and non-conductive material, and the material can be chosen to prevent or reduce eddy current loss.

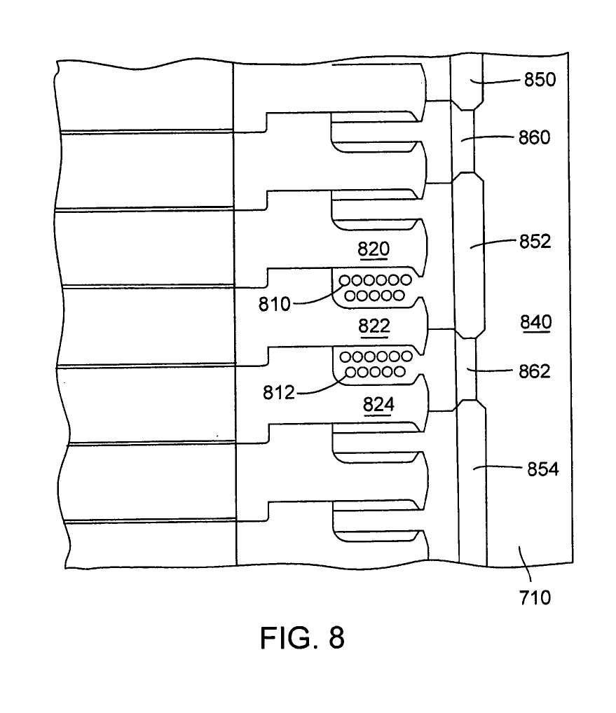

FIG. 8 is a close-up vertical sectional view of the portion of the armature indicated in FIG. 7. In this view, a plurality of wire coils 810, 812 are shown positioned in wire receiving pockets between and defined at least in part by the teeth 820, 822, 824. In the depicted embodiment, the magnet compartment 710 comprises a backiron 840 and one or more magnets 850, 852, 854 and one or more retainers 860, 862.

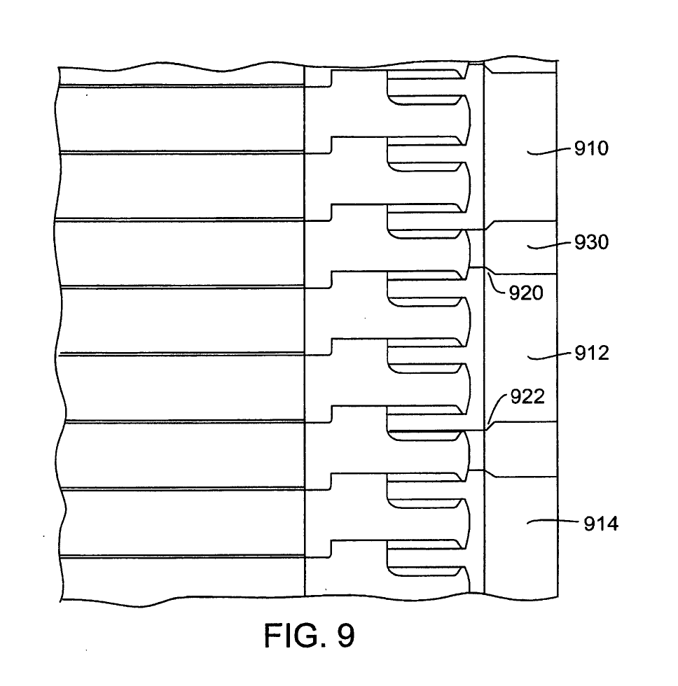

FIG. 9 shows a close-up vertical sectional view of another embodiment of an armature portion similar to the portion indicated in FIG. 7. In this embodiment, magnets 910, 912, 914 comprise flared tips (e.g., tips 920, 922 on magnet 912) positioned at the side of the magnet that faces the armature. In such embodiments, one or more retainers 930 can be used to hold the magnets 910, 912, 914 in place.

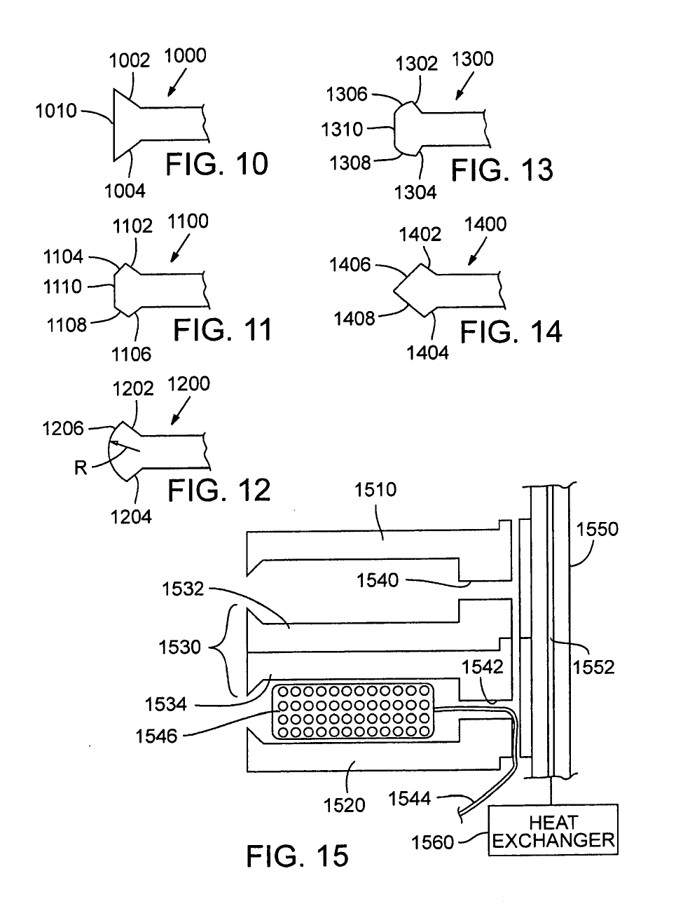

Returning briefly to FIG. 8, armature teeth such as teeth 820, 822, 824 have various shapes in various embodiments. FIGS. 10-14 depict cross-section views of various embodiments of exemplary teeth tips that can be used with armature embodiments described herein. In some embodiments, the tips comprise a plurality of surfaces that generally diverge to a common surface (e.g., a common flat surface, a common curved surface). For example, FIG. 10 shows an embodiment of a “flared” tip 1000 comprising inclined surfaces 1002, 1004 extending to a generally flat surface 1010. In further embodiments, the tips comprise a plurality of surfaces that generally diverge and then converge. In some cases such tips converge to a common surface. For example, FIG. 11 shows an embodiment of a tip 1100 comprising inclined surfaces 1102, 1104, 1106, 1108 that lead to a generally flat surface 1110. As an example of a further embodiment, FIG. 12 shows a tip 1200 comprising inclined surfaces 1202, 1204 leading to a convex, generally rounded surface 1206 having a radius R. In some embodiments, R can be based at least in part on the pole pitch of the magnets in the magnet compartment. In at least this context, “pole pitch” can be defined as the distance between the north and south poles of the magnets positioned opposite the tip. According to some embodiments,

$$R = \frac{polepitch}{π}$$

For example, given a pole pitch of 72 mm, R=22.9 mm.

FIG. 13 shows an additional embodiment of a tip 1300, which comprises inclined surfaces 1302, 1304 leading to respective curved surfaces 1306, 1308. The curved surfaces are also adjacent a generally flat surface 1310. FIG. 14 shows an additional embodiment of a tip 1400 comprising inclined surfaces 1402, 1404, 1406, 1408. In at least some embodiments, armature tooth shoe designs can be selected to change variations in magnetic flux in an armature during operation (e.g., as the poles move relative to the magnets). A change in flux can produce a proportional change in a generator's output voltage. Generally, the output voltage waveform for a given cyclic flux variation can take a variety of shapes. For example, the waveform can take a sinusoidal or trapezoidal shape, or a combination of these shapes. In at least some embodiments a selected output voltage waveform can be achieved using a particular tooth shoe design and/or magnet pole shaping.

In further embodiments, armature tooth shoe designs can also affect a net sum of forces along an axis of motion in the generator. The combined sums of magnetic forces along the axis of motion are commonly known as “cogging forces.” A selected tooth shoe design and a selected armature length can reduce cogging forces. In at least some embodiments, for a given armature length, a fractional pole pitch can be determined to fit a given number of slots and teeth. In at least some embodiments, for a three-phase machine, a fractional pole pitch α_{cp} can be determined by the equation

$${a}_{cp} = \frac{polepitch}{3 {τ}_{s}}$$

where τₛ is the distance between the centers of adjacent armature teeth, sometimes known as the “slot length.” The distance τₛ comprises a slot width and a tooth width, and in at least some embodiments one or both of these widths are selected to avoid magnetic flux saturation in the teeth.

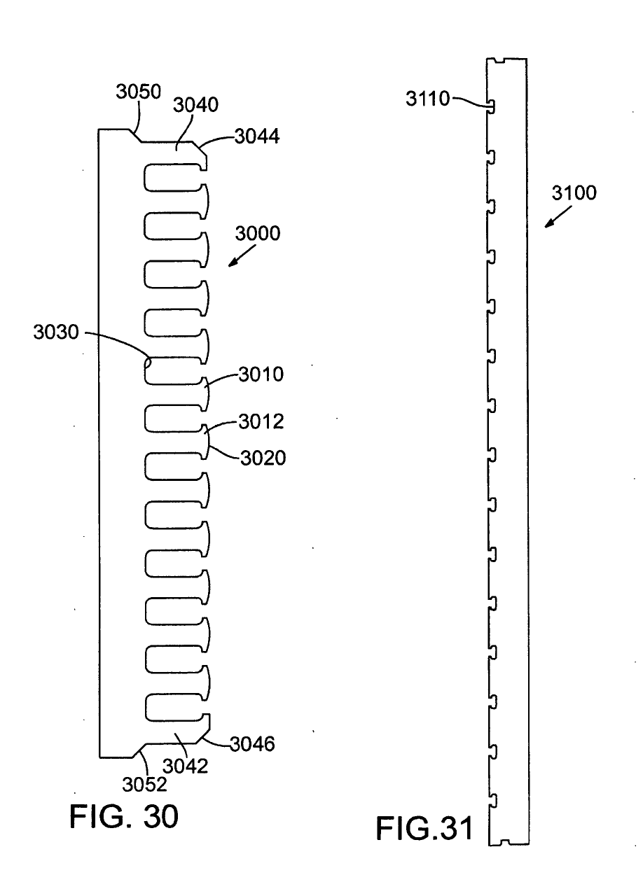

In some embodiments the design can comprise an even number of slots and an odd number of teeth. As explained below with respect to FIG. 30, in some embodiments one or more end teeth on an armature (with respect to the direction of relative motion of the armature) can be shaped for reduced cogging given a selected tooth width.

One exemplary method for determining an armature length that can minimize cogging forces (for a configuration where the armature is shorter than an associated translator, e.g., where the armature is shorter than the total number of magnetic pole lengths in the translator) is:

armature length=[(poles−1)×polepitch]+magnetic pole length

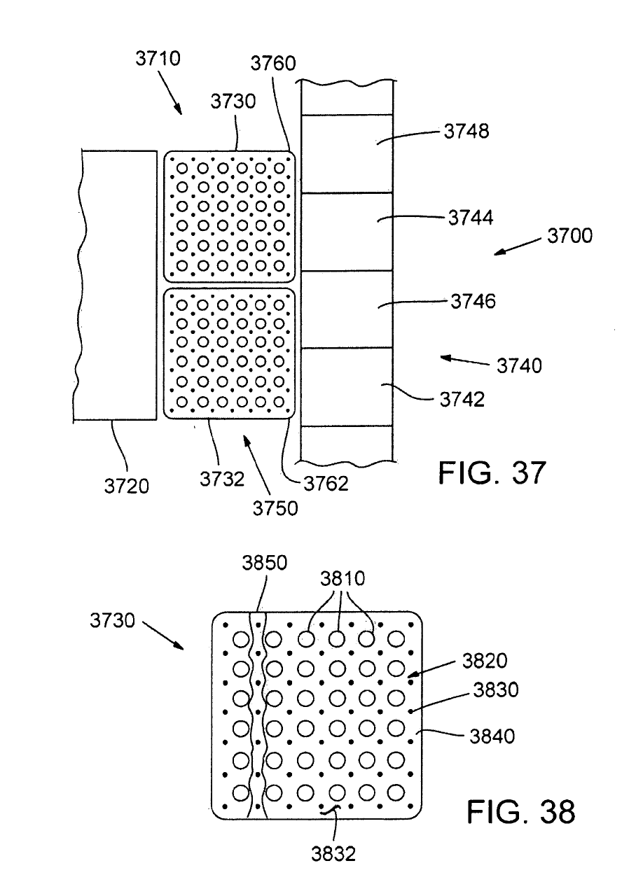

In the above equation, poles is the number of magnetic poles in the armature and magnetic pole length is the length of a magnet pole as measured along the axis of motion. This equation applies to designs with a consistent reluctance (e.g., no teeth) in the active region of the armature, such as an air gap wound machine with selected permeability. An exemplary embodiment of such a machine appears in FIG. 37, which shows a vertical sectional view of a portion of an embodiment 3700 where an armature 3710 comprises a backiron 3720 and a plurality of wire coils 3730, 3732. A field 3740 (e.g., a magnet housing) comprises a plurality of magnets 3742, 3744 and poles 3746, 3748. The wire coils 3730, 3732 are positioned in a gap 3750 between the backiron 3720 and the field 3740.

In some embodiments, an effective magnetic pole length and an effective armature length can be determined according to the amount of magnet pole shaping (e.g., by varying the magnetic pole length) and end tooth tapering, respectively. In particular embodiments a calculated armature length can be varied to create and effective armature length by altering the shape of armature end teeth 3760, 3762. The effective armature length can differ from the calculated armature length by approximately ±1, 5, 10 or 20 percent of the pole pitch value.

As shown in FIG. 15, in some embodiments tooth sections 1532, 1534 on two adjacent armature ring sections 1510, 1520 can form a tip 1530. Other plural section tips can also be employed. For example, any one of the tips described above in connection with FIGS. 10-14 can be a plural section tip. The embodiment of FIG. 15 also shows exemplary ring sections 1510, 1520 with wire passageways or conduits 1540, 1542. The conduits provide exit points, e.g., for a wire 1544 from a wire coil 1546 positioned in the ring section 1520. A backiron 1550, coupled to the ring sections 1510, 1520 can be used as a heat sink for the ring sections. In some embodiments, the backiron 1550 can be provided with one or more cooling passageways or conduits, such as a vertically extending conduit 1552, perpendicular to conduits 1540, 1542. Conduit 1552 can be used for carrying cooling fluid or a refrigerant (e.g., water, sea water, or other coolant). The conduit 1552 can be coupled to a heat exchanger 1560 and a pump (not shown).

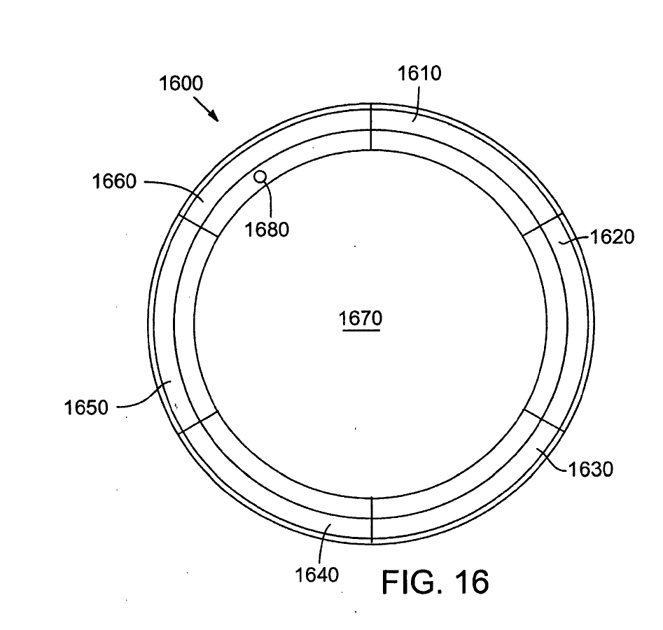

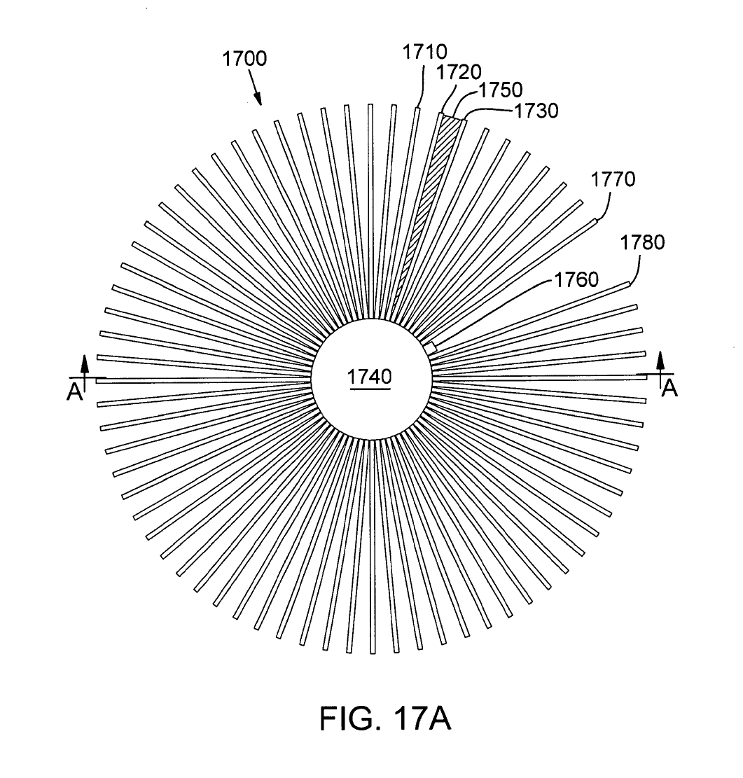

In particular embodiments, an armature ring section (e.g., ring sections 720, 730 in FIG. 7) can comprise one or more ring sub-sections. FIG. 16 shows a plan view of a ring section 1600 that is similar to the ring sections 720, 730. In the depicted embodiment, the ring section 1600 is comprised of six subsections 1610, 1620, 1630, 1640, 1650, 1660. Further embodiments can comprise more or fewer subsections. The subsections define an aperture 1670. Further embodiments of the ring section 1600 comprise one or more features for promoting alignment of vertically adjacent ring sections, such as interlocking ridges (not shown) and/or one or more pins (e.g., a pin 1680) and corresponding pin receiving holes.

Although the armature ring section embodiments shown in FIGS. 7-9 show ring sections with one tooth, in further embodiments an armature ring section has two or more teeth. In particular embodiments, the armature can be comprised of only one ring section that has all teeth for the armature.

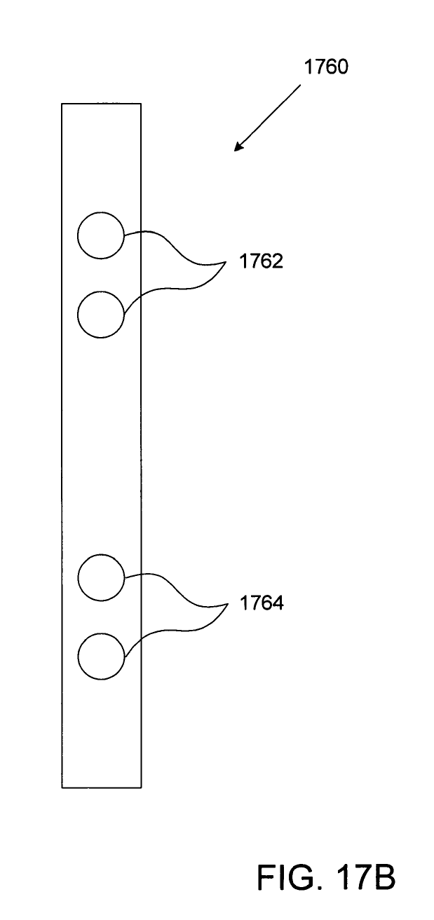

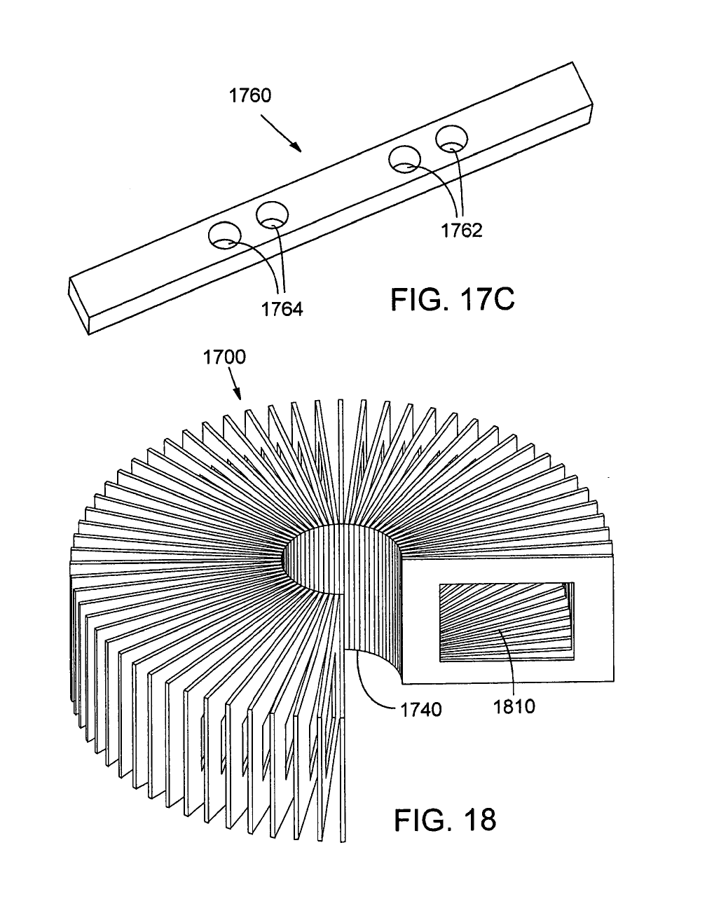

Components for ocean wave energy converter systems described herein can be made using a variety of methods and can have a variety of compositions. In some embodiments, one or more components (e.g., an armature and/or a magnet compartment) can comprise a plurality of radial laminations. As used herein, “radial laminations” refers to laminations that can have major surfaces oriented generally in (but not necessarily perpendicular to) the direction of motion of the component comprised of the laminations. These laminations can have planar, parallel major opposed surfaces. FIG. 17A shows a plan view of a component 1700 comprising a plurality of radial laminations, such as laminations 1710, 1720, 1730. In at least some embodiments, the laminations define an opening 1740, such as an opening having a circular or other shaped cross-section. A wire exit guide 1760 can be positioned near the opening 1740 and between radial laminations 1770, 1780 to provide an entrance and/or exit route for wires going in and out of the component 1700. FIG. 17B shows a side view of the wire exit guide 1760, which in the depicted embodiment features upper holes 1762 and lower holes 1764 for receiving wires entering or exiting the component 1700. FIG. 17C shows a perspective view of the wire exit guide 1760. The laminations 1710, 1720, 1730 generally comprise a thin ferro-magnetic material with an insulation (usually a thin insulation) on the outer surface. Laminations can be made of, for example, Fe, Fe—Si, Superpermalloy; or other materials (e.g., C4 M19 Silicon Lamination Steel, available from Proto Laminations, Inc.). In various embodiments, the lamination material can be chosen based on one or more considerations such as permeability, insulation, environment temperature, magnetic saturation, and/or structural design considerations. In at least some embodiments, a component constructed of radial laminations maintains a constant cross-section of ferro-magnetic material, allowing for a constant flux density and optimized ferro-magnetic material utilization.

In further embodiments one or more filling materials can be placed between some or all of the laminations, e.g., to provide support for the laminations. For example, a filling material 1750 can be positioned between the laminations 1720, 1730 (and also between other laminations). Exemplary filling materials include epoxies, polymers and/or thermosetting resins. Generally, the filling material 1750 can be selected such that the spaces between the laminations are relatively light. For example, in some embodiments the filling material 1750 weighs about one fourth of what an equivalent volume of iron fill would weigh. Thus, the filling material 1750 can be used to reduce the weight of the finished component 1700.

FIG. 18 shows a perspective view of an embodiment of the component 1700 with an approximately 90-degree portion of the laminations removed. This view shows that, in at least some embodiments, the laminations can be configured to provide a cavity 1810. The cavity 1810 can be generally annular extending through adjacent laminations along any portion of the 360 degrees of the component. The cavity 1810 can be an interior cavity spaced from the peripheral edges of the laminations. In particular embodiments, the component 1700 is used to form an armature, and the cavity 1810 holds a wire coil for the armature, as shown below. In some such embodiments, the opening 1740 is available to receive a spar comprising a magnet compartment.

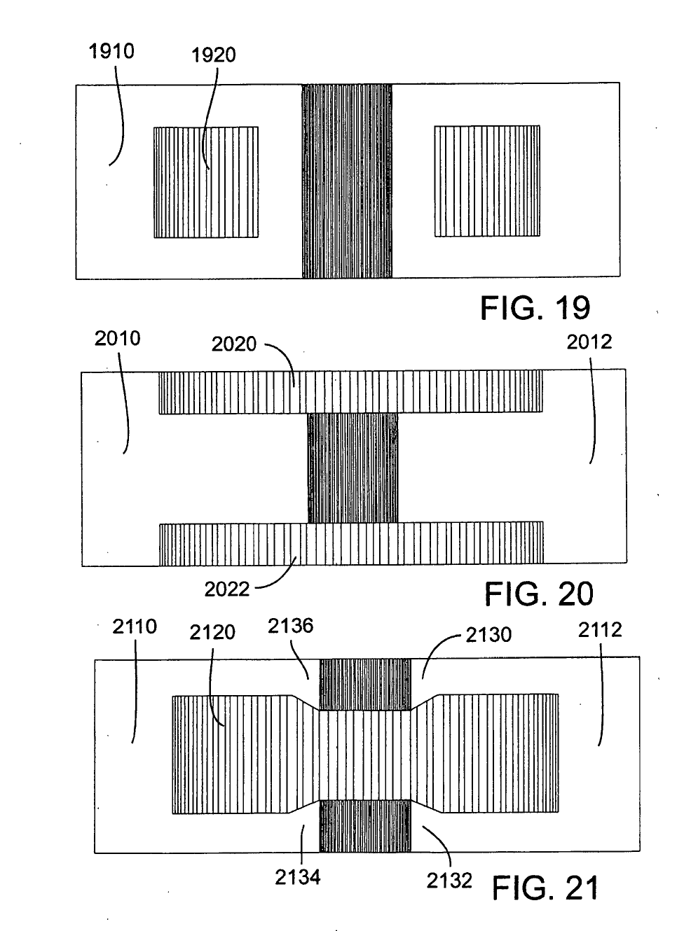

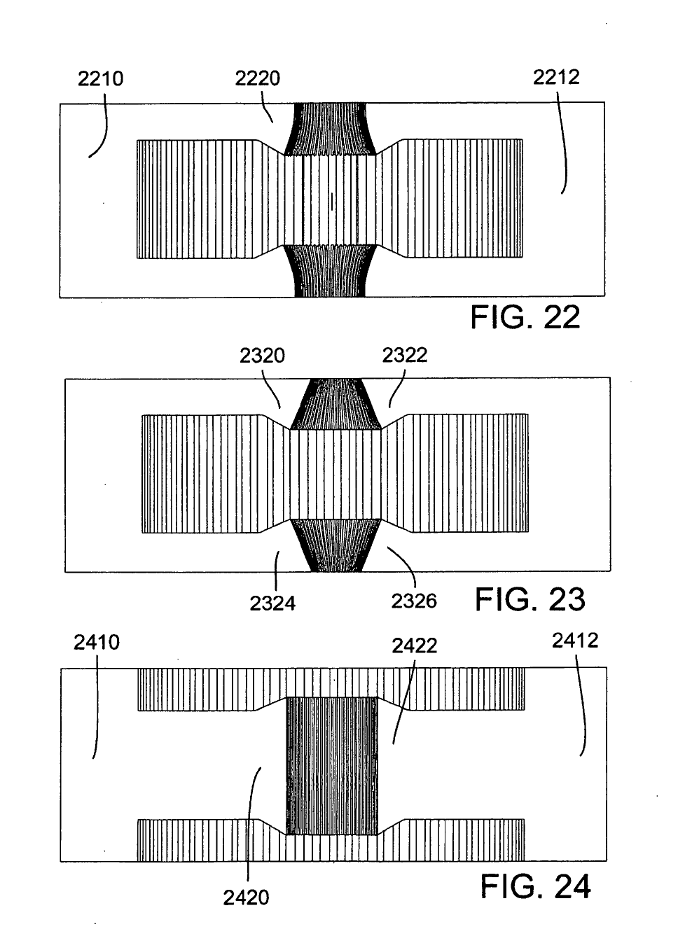

FIGS. 19-24 show vertical sectional views of various exemplary embodiments of the component 1700, as taken along a line corresponding to the line A-A of FIG. 17. FIG. 19 depicts an embodiment where laminations, such as a lamination 1910, form an annular cavity 1920 bounded on four sides by the individual laminations. FIG. 20 depicts an embodiment where laminations, such as laminations 2010, 2012, define an upper cavity 2020 and/or a lower cavity 2022, as well as one or more pole tips 2030. FIG. 21 depicts an embodiment where laminations 2110, 2112 form an annular cavity 2120 bounded on three sides by the individual laminations. In the embodiment of FIG. 21, the laminations 2110, 2112 comprise partial pole tips (e.g., partial tips 2130, 2132, 2134, 2136) which can be used to form plural section tips (see, e.g., FIG. 15 and the above corresponding discussion). The laminations of the embodiment of FIG. 21 can be used to form a plural section tip having a form, for example, similar to that of tip 1000 in FIG. 10. FIGS. 22 comprises laminations 2210, 2212, which comprise partial pole tips such as partial tip 2220. The laminations of FIG. 22 can be used to form a plural section tip having a form, for example, similar to that of tip 1200 in FIG. 12. FIG. 23 shows an embodiment with laminations having partial tips 2320, 2322, 2324, 2326 that can be used to form a plural section tip having a form similar to that of tip 1400 of FIG. 14. FIG. 24 shows laminations 2410, 2412 which are similar to those of FIG. 20, but which comprise pole tips 2420, 2422 similar to those of tip 1000 of FIG. 10.

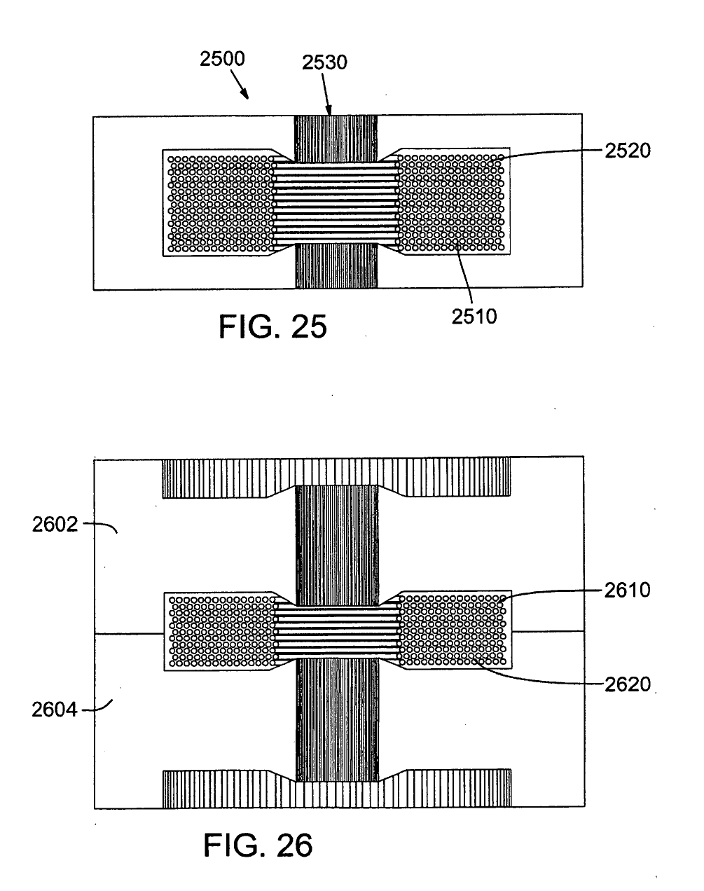

FIG. 25 shows a vertical sectional view of an armature component 2500 (using the lamination embodiment of FIG. 21), further comprising a wire coil 2510 positioned in a cavity 2520. The wire coil 2510 is positioned such that a central longitudinally extending opening is available to receive a spar. Although at least some of the embodiments of FIGS. 17-24 are shown as lending themselves to forming an armature with teeth on the inner circumference of the armature, further embodiments can be configured to form an armature with teeth on the outer circumference of the armature.

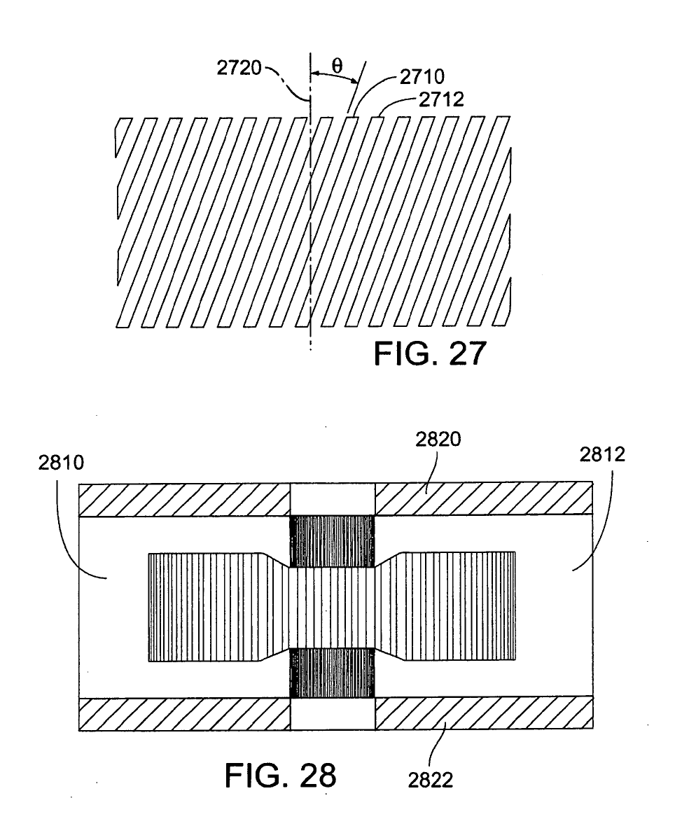

Generally, pluralities of components comprising radial laminations, such as those shown in FIGS. 17-25, can be stacked on each other. For example, FIG. 26 shows two components 2602, 2604 (like the components of FIG. 24) stacked together so as to form a cavity 2610, which in the depicted embodiment contains a wire coil 2620.

FIG. 27 shows a side elevational view of an embodiment similar to the component 1700 of FIG. 17. Radial laminations such as laminations 2710, 2712 are desirably parallel or approximately parallel to each other. In at least some cases, this configuration reduces losses due to eddy currents. In some embodiments, the laminations 2710, 2712 are skewed or oriented at an angle θ to a longitudinal axis 2720 extending through the center of the component. For example, when the component 1700 is used in conjunction with embodiments of ocean wave energy converter systems described herein, the axis 2720 can be the axis along which the float and the spar move relative to each other. In certain embodiments, θ is equal to or approximately equal to zero degrees, while in further embodiments θ=±1, 5, 10 or 20 degrees. In various embodiments, all of these are included in the phrase “oriented generally in the direction of motion.” A particularly desirable angle is zero degrees, which in at least some embodiments results in a lowest induced eddy current loss. Other angles can have mechanical and/or structural purposes and can sometimes reduce eddy current loss. Other embodiments can comprise laminations oriented at other angles and/or one or more angles.

Components, such as the component 1700, can be assembled using a variety of methods and devices. For example, FIG. 28 shows a vertical sectional view of a plurality of laminations (e.g., laminations 2810, 2812) inserted between and held in place by compression rings 2820, 2822. The compression rings can be any suitable material, with fiberglass being a specific example. In further embodiments, a lamination can be spaced apart from adjacent laminations by one or more shims, spacers and/or fillers.

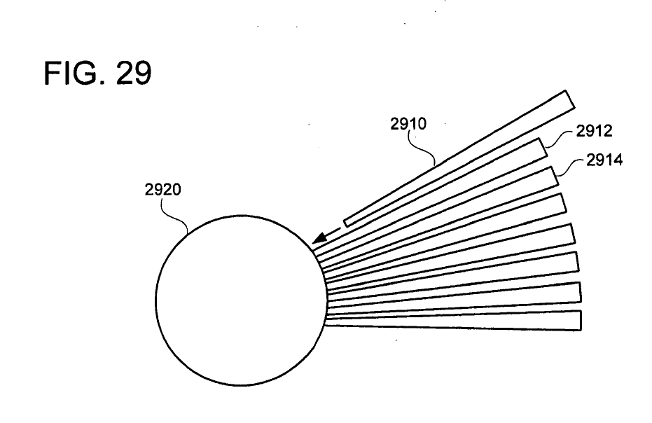

As another example, FIG. 29 shows a plan view of a holder 2920 (e.g., a slotted spool or other device) configured to receive laminations 2910, 2912, 2914. The holder 2920 can retain the laminations 2910, 2912, 2914 until they are fixed (e.g., using a filler or other device or substance). Alternatively, the holder 2920 can remain in place and can include a central aperture to receive a spar. FIG. 29 also shows an embodiment of laminations 2910, 2912, 2914 having a non-uniform thickness. In the depicted embodiment, the thickness of the laminations increases as the laminations extend radially outward.

FIG. 30 shows an embodiment of an exemplary radial lamination 3000 for constructing an armature. The lamination was designed for an embodiment where the armature comprises only one ring of laminations, although in further embodiments the lamination 3000 (or similar laminations) can be shorter and used to form an armature ring with a plurality of stacked rings used to form an armature. Teeth (e.g., teeth 3010, 3012) forming portions of the lamination 3000 comprise flared tips with curved surfaces (e.g., curved surface 3020). The base of slot-forming portions of the lamination between the teeth can comprise rounded corners (e.g., corner 3030) which in at least some cases minimize the effects of corner flux saturation. A top tooth 3040 forming portion and a bottom tooth 3042 forming portions comprise tapered edges 3044, 3046 (e.g., about 45 degrees), which can reduce cogging effects. Rear tapered edges 3050, 3052 can serve as mechanical stops when, for example, the lamination 3000 is inserted into a ring assembly structure such as that shown in FIG. 28.

FIG. 31 shows an embodiment of an exemplary backiron lamination 3100 that can be used for constructing a backiron section (e.g., the backiron sections 610, 612 of FIG. 6). The lamination 3100 comprises a plurality of grooves 3110 configured to receive one or more retainers 640, as described above. In some embodiments, the grooves 3110 are T-shaped so as to avoid interference with a magnetic flux path in the backiron section 610, 612. In at least some embodiments, the T-shaped grooves help avoid narrowing the flux path in the backiron lamination with respect to magnet pole length. Generally, a flux path narrower than the magnet pole length results in flux concentration, which can in turn lead to flux saturation. Abrupt changes in the flux path can create undesired areas of flux saturation in the backiron and also promote flux leakage and fringing at the magnet edges.

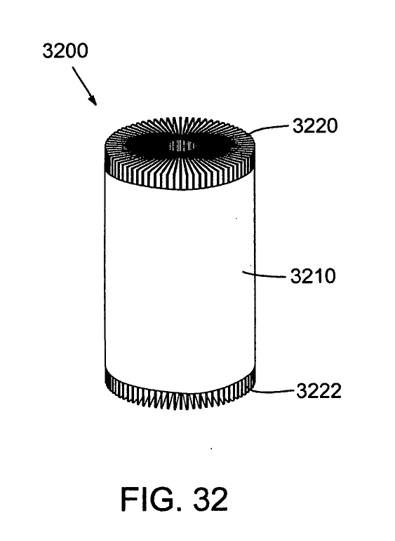

Returning briefly to FIG. 6, in some embodiments the backiron components 610, 612 of the magnet compartment 460 can be comprised at least partially of a plurality of radial laminations, as explained in more detail below. Also, FIG. 32 shows an embodiment of a magnet housing component 3200, which can be used as part of a spar or buoy, for example. The exemplary component 3200 comprises a magnet 3210 and one or more radial lamination end pieces 3220, 3222. In some embodiments, a plurality of magnets are placed vertically end-to-end, with one or more radial lamination end pieces between the magnets. In some embodiments, the end pieces 3220, 3222 can act as flux concentrating pole pieces by providing flux paths above and/or below a given magnet.

In further embodiments, the radial lamination end pieces are comprised of non-magnetic materials. These materials can be, for example, aluminum and/or fiberglass. The end pieces can provide mechanical and structural integrity. They preferably have a low relative permeability, which can make them less likely to interfere with electrical or magnetic aspects of the system.

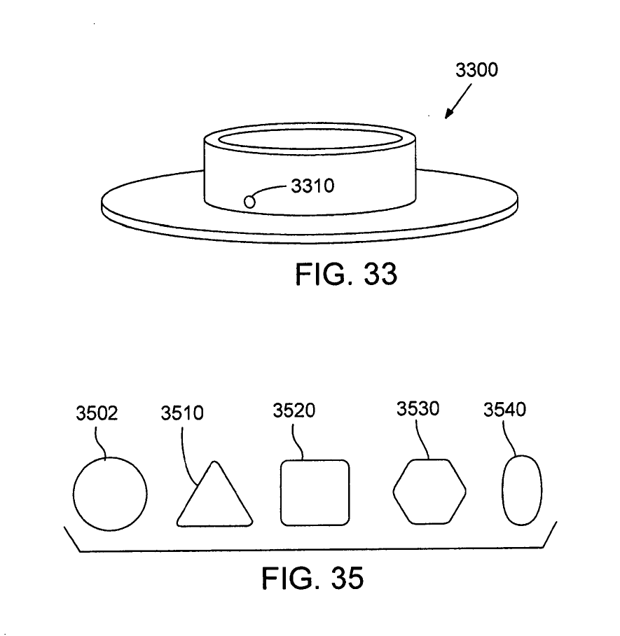

In at least some embodiments wire coils, such as those shown in FIGS. 8, 15, 25 and 26, can be fabricated by winding wire around a bobbin, such as one made of a plastic (e.g., Delrin). The bobbin-supported wire coil can be placed between armature teeth (e.g., between the teeth 820, 822 of FIG. 8), which in at least some cases provides assembly time savings. FIG. 33 shows a perspective view of one embodiment of an exemplary bobbin 3300. In some embodiments a bobbin is keyed or pinned to provide for a desired rotary position of the bobbin during installation into the armature. In some embodiments a binder, such as an epoxy or other resin, is used during the bobbin winding process to form a solid winding structure. In further embodiments the bobbin can be removed after a wire coil is formed on the bobbin.

In further embodiments a bobbin can comprise an exit aperture or groove 3310 through which a wire from a wire coil can pass. In particular embodiments, the aperture 3310 can comprise a connector socket coupled to a connector plug that is integrated with another armature component such as a ring. Such embodiments can reduce undesired air gaps in the armature by allowing for a relatively small hole that provides a path through the armature to the bobbin. In some embodiments, a wire coil wound on the bobbin 3310 is one wire high and comprises a plurality of turns in the radial direction. When used in an armature similar to those described in this application, this configuration allows for a maximum number of phases.

In additional embodiments, a wire coil is initially wound directly between teeth of an armature rather than on a separate support structure such as a bobbin.

FIG. 38 shows a close-up vertical sectional view of the wire coil 3730 of FIG. 37, which in the depicted embodiment shows round cross-sections of a plurality of wires 3810. Generally, wires wound into a coil such as the wire coil 3730 have a plurality of gaps (e.g., gap 3820) between adjacent wires. In a wire coil wound of round wires, generally a fill factor of about 80% wire is achieved. When gaps such as gap 3820 are filled with non-magnetic materials (e.g., air), these gaps can inhibit the magnetic flux path in the coil. In the embodiment of FIG. 38, gaps between the wires 3810 are filled at least in part by a plurality of particles 3830 suspended in a carrier substance 3840, in order to increase the magnetic permeability of spaces between the wires 3810. The particles 3830 comprise one or more magnetic materials such as, but not limited to, iron, iron alloys, Permalloy, nickel alloys, chromium alloys, cobalt alloys, and other materials with a generally high magnetic permeability. In some embodiments the particles 3830 have an average diameter of about 50-100 microns, but smaller or larger particles can also be used. In a particular embodiment, particles of about 325 mesh (a diameter of about 44 microns) are used. In further embodiments the particles 3830 can comprise particles of multiple sizes. The carrier substance 3840 can comprise, for example, an epoxy, plastic and/or resin. The concentration of the particles 3830 in the carrier substance 3840 can range from about 1% to about 100%. Varying the concentration of ferrous material in the fill can alter one or more magnetic properties of the space occupied by the wire coil and the fill. For example, the relative permeability can be altered.

In at least some embodiments the particles in the carrier substance 3840 are non-spherical. For example, the particle 3832 has a generally elongated shape. Such an elongated particle 3832 can be oriented in one or more particular directions. In some embodiments, the particle 3832 can be aligned with a magnetic field to which the armature is subjected (e.g., perpendicular to the direction in which the wires of the coil 3730 are wound). Such oriented elongated particles can result in a magnetic permeability that is directionally dependent. In some cases, this could be used to direct flux in a preferred direction.

In further embodiments, one or more generator components (e.g., an armature and/or a magnet compartment) can be molded out of one or more carrier substances containing a plurality of magnetic particles, such as those described above.

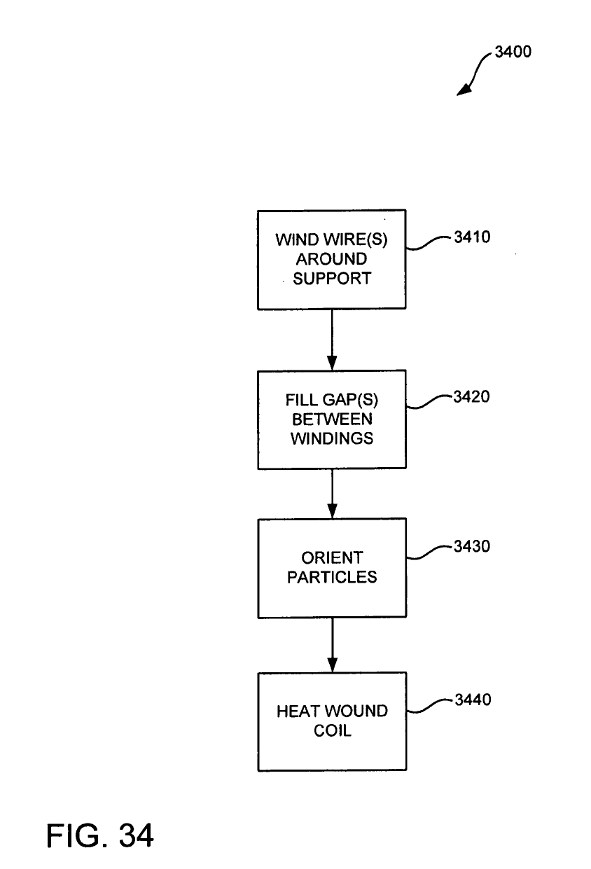

FIG. 34 shows a flowchart of an embodiment of a method 3400 for filling air voids in a wire coil. In a method act 3410, one or more wires are wound around a support (e.g., a bobbin, an armature component, or other support). In particular embodiments the one or more wires are wound relatively loosely to create gaps in the wire coil. The gaps can be, for example, about 20% to about 90% of the fill volume of the wire coil. In some embodiments, one or more gaps between wires are created by placing material between wires, e.g., as the wire coil is being wound. For example, turning briefly to FIG. 38, a piece of material 3850 created a gap among some wires of the coil 3730. Such oriented elongated particles can result in a magnetic permeability that is directionally dependent. In at least some cases, this could be used to direct flux in a preferred direction. Returning to FIG. 34, in a method act 3420 one or more gaps between the windings are filled. In some embodiments the gaps are filled by applying a coating (e.g., as was discussed above with respect to FIGS. 37 and 38) with the fill to the wire as it is wound onto the support. The coating can be applied during winding of the coil. For example, the coating can be applied using a brush or a syringe applicator. In further embodiments, the fill is applied to a partially or fully wound coil using vacuum filling. In embodiments where gaps between wires are created using one or more pieces of material, as described above, properties of the material can be used to fill the gaps. For example, in some embodiments the material has wicking properties (e.g., in the case fabrics such as cotton or fiberglass) which can draw a coating into at least some of the gaps.

In embodiments where the fill comprises elongated particles (such as 3832 described above with respect to FIG. 38), in a method act 3430 the elongated particles can be arranged in a specific orientation. This can be accomplished, for example, by applying a magnetic field to the fill before the fill has set.

In some cases, in a method act 3440, a wire coil is heated to better distribute the fill through the coil. At least some of these embodiments can provide for a homogenous distribution of ferrous material in the wound coils of an armature.

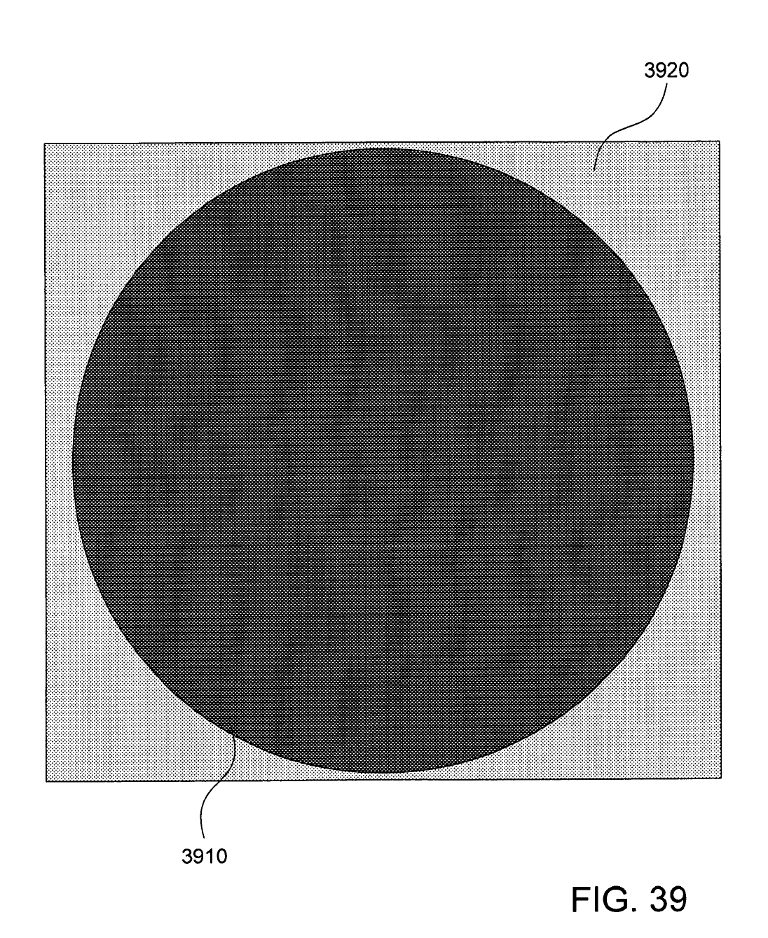

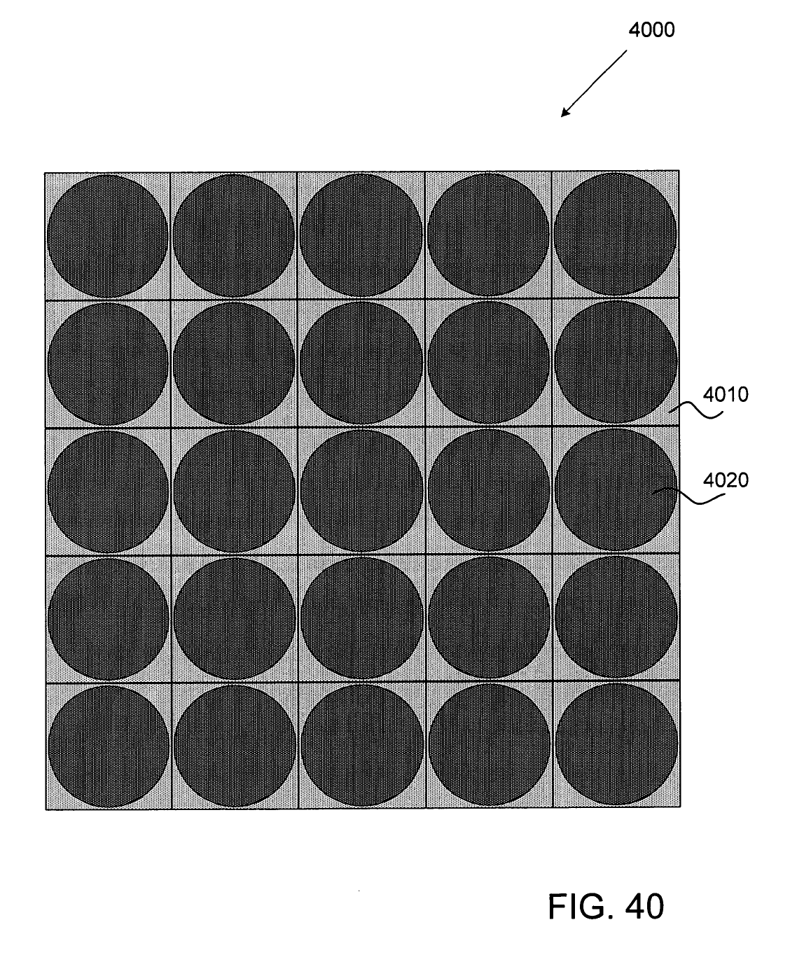

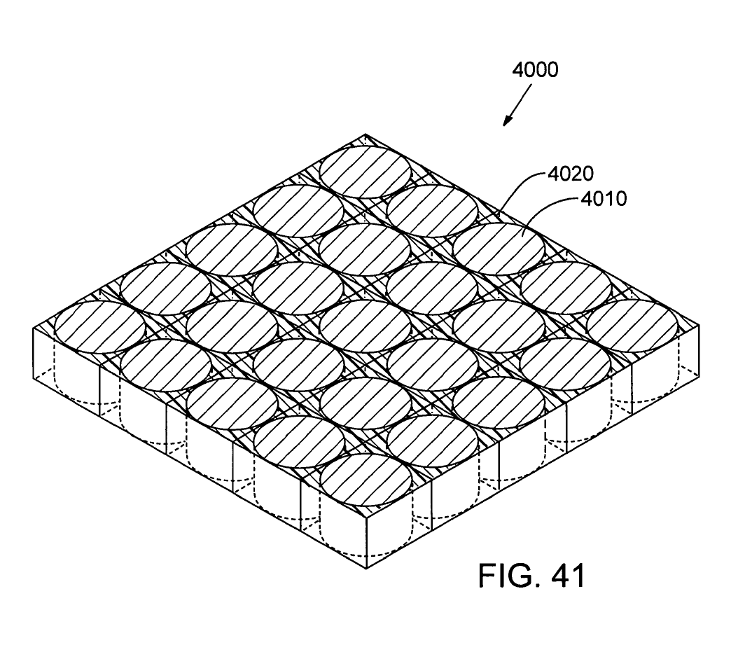

In further embodiments, a wire can be manufactured with a configuration designed to achieve a higher fill volume. For example, in some embodiments a wire coil is made of one or more wires having a cross-section allowing for a relatively high fill volume. FIG. 35 shows exemplary cross-sections of wires 3510, 3520, 3530 that can be used to make a relatively low air gap coil (e.g., triangular, rounded square, trapezoidal, diamond, hexagonal). Generally, wires having polygonal cross-sections (e.g., as shown in FIG. 35) can be wound more closely than wires with round cross-sections, thus reducing air gaps in the coil. However, wires having round cross-sections 3502 or oval cross-sections 3540 can also be used. For additional embodiments, a wire can be manufactured with a fill designed to give the cross-section of the wire a selected shape. For example, FIG. 39 shows the circular cross-section of a wire 3910 encased at least in part by a fill portion 3920 designed to provide a square cross-section. FIG. 40 shows the cross-section of an exemplary wire coil 4000 made with wire similar to that of FIG. 39. As shown in FIG. 40, fill portions such as portion 4020 can reduce gaps between the wire 4010 and its neighboring wires. FIG. 41 shows a perspective view of a slice of the wire coil 4000.

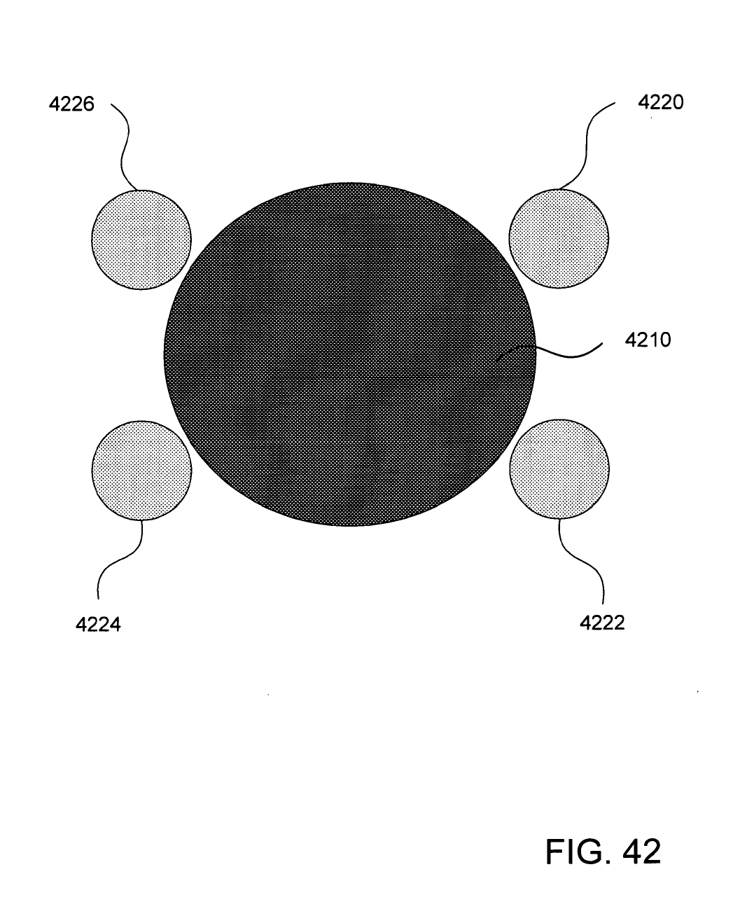

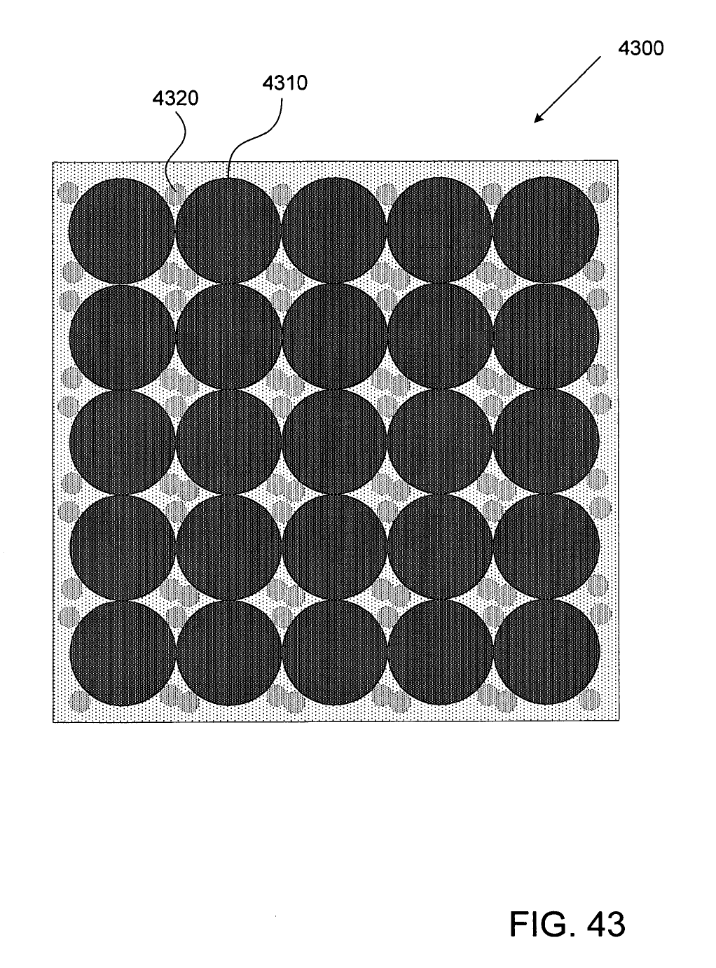

In still further embodiments, a wire can be at least partially wrapped in a fill material. For example, FIG. 42 shows a cross-sectional view of a wire 4210 that is wrapped in a plurality of fill threads 4220, 4222, 4224, 4226. FIG. 43 shows a cross-sectional view of an exemplary wire coil 4300 made using wire similar to that of FIG. 42.

In some cases, wire embodiments such as those shown in FIGS. 39-43 are manufactured with one or more exterior orientation marks to aid in winding the wire. Also the embodiments of FIGS. 39-43 can also be heated, as described above with respect to the method act 3440.

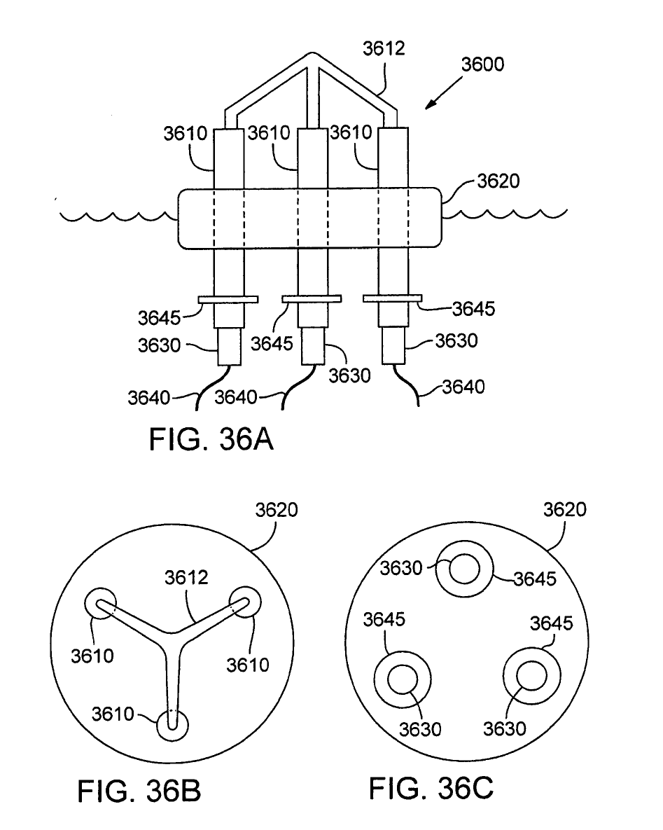

FIG. 36A depicts an ocean wave energy converter system 3600, which comprises a float 3620 and two or more spars 3610. The particular embodiment shown features three spars 3610 surrounded by float 3620. Spars 3610 are reinforced from above by support structure 3612, but in other embodiments a support structure on the underside of system 3600 can be added. In another embodiment no support structure is present. Spars 3610 and float 3620 together comprise systems similar to those described previously in this application. Similar to other embodiments described above, ballast weights 3630 and wave plates 3645 can be attached to spars 3610, and the spars can be held in place using tethers 3640.

FIG. 36B provides a top view of system 3600, showing float 3620, spars 3610 and support structure 3612. The top ends of the spars 3610 can have caps as in other disclosed embodiments, although they are not shown in FIGS. 36A or B. FIG. 36C is a bottom view of system 3600, showing float 3620, ballast weights 3630 and wave plates 3645.

In view of the many possible embodiments to which the principles of the disclosed technologies may be applied, it should be recognized that the illustrated embodiments are only preferred examples of the technologies and should not be taken as limiting the scope of the invention. Rather, the scope of the invention is defined by the following claims. We therefore claim as our invention all that comes within the scope and spirit of these claims.

We claim:

1. An apparatus for converting wave motion to electrical power, wherein the system is at least partially immersed in a liquid through which the waves travel, the apparatus comprising:
a first component having an overall buoyancy relative to the liquid so as to float in the liquid;
a second component movably coupled to the first component, wherein the second component is configured to move relative to the first component in a direction of motion in response to a force from waves that is exerted on the first component; and
an electrical generator coupled to the first and second components, the electrical generator comprising an armature and a magnet housing, wherein at least one of the armature and the magnet housing comprises a plurality of laminations having major surfaces oriented in the direction of motion.

2. The apparatus of claim 1, wherein the armature comprises the plurality of laminations having major surfaces oriented generally in the direction of motion.

3. The apparatus of claim 2, wherein the plurality of laminations form a plurality of vertically spaced apart projections extending toward the magnet housing, the projections comprising distal and proximate end portions, the distal end portions having distal end surfaces spaced by a gap from the magnet housing, the armature also comprising a backing portion interconnecting proximate end portions of the projections, wherein magnetic flux paths are provided through the distal end portions of the projections and backing portion, the projections defining electrically conductive wire receiving pockets therebetween, and electrical wires positioned at least partially within the wire receiving pockets and coupled to at least one power output.

4. The apparatus of claim 3, wherein at least a plurality of the distal ends of the projections are enlarged to increase a volume of said distal end portions and wherein at least a portion of the distal end surface of at least a plurality of distal end portions has a curvature.

5. The apparatus of claim 3, wherein the at least a plurality of the distal ends of the projections are enlarged to increase a volume of said distal end portions and wherein at least a portion of the distal end surface of at least a plurality of distal end portions is convex.

6. The apparatus of claim 3, wherein the at least plurality of the distal ends of the projections are enlarged to increase a volume of said distal end portions and wherein at least a plurality of the distal end surfaces comprise a flat central portion parallel to the direction of travel of the magnet housing and a curved peripheral portion.

7. The apparatus of claim 2, wherein the plurality of laminations comprising the armature are configured in a plurality of rings stacked generally in the direction of motion.

8. The apparatus of claim 2, wherein the plurality of laminations comprising the armature extend in a radial direction and together define an opening through which the magnet housing is inserted.

9. The apparatus of claim 2, wherein the plurality of laminations comprising the armature extend in a radial direction and together define a circumference around which the magnet housing is placed.

10. The apparatus of claim 1, further comprising a fill material positioned between first and second laminations of the plurality of laminations.

11. The apparatus of claim 1, wherein at least some of the plurality of laminations are coupled to a component providing one or more apertures for receiving wires in the armature or magnet housing.

12. The apparatus of claim 1, wherein at least one of the laminations in the plurality of laminations has a non-uniform thickness.

13. The apparatus of claim 12, wherein the at least one of the laminations in the plurality of laminations has a thickness that increases as the lamination extends radially outward.

14. The apparatus of claim 1, wherein the plurality of laminations form a plurality of ring segments.

15. The apparatus of claim 1, wherein the magnet housing comprises at least one magnet and at least some of the plurality of laminations having major surfaces oriented generally in the direction of motion.

16. The apparatus of claim 15, wherein at least some of the plurality of laminations comprising the magnet housing comprise a T-shaped groove.

17. The apparatus of claim 1, further comprising a heat exchanger configured to remove heat from the armature.

18. The apparatus of claim 17, further comprising one or more coolant passageways in the armature, the one or more coolant passageways being coupled to the heat exchanger.

19. An apparatus for converting wave motion to electrical power, wherein the system is at least partially immersed in a liquid through which the waves travel, the apparatus comprising:
a first component having an overall buoyancy relative to the liquid so as to float in the liquid;
a second component movably coupled to the first component, wherein the second component is configured to move relative to the first component in a direction of motion in response to a force from waves that is exerted on the first component; and
an electrical generator coupled to the first and second components, the electrical generator comprising an armature and a translator, wherein the armature comprises one or more coils, the coils comprising electrically conductive wires with one or more ferrous materials positioned between the wires.

20. The apparatus of claim 19, wherein at least a portion of the electrically conductive wires have a round, oval or polygonal cross-section.

21. The apparatus of claim 19, wherein the electrically conductive wires with one or more ferrous materials positioned between the wires comprise one or more wires coated with the one or more ferrous materials before being wound into the coils.

22. The apparatus of claim 19, wherein the electrically conductive wires with one or more ferrous materials positioned between the wires comprise one or more wires wound into the coils with one or more cords comprised of the ferrous materials.

23. The apparatus of claim 19, wherein the one or more ferrous materials positioned between the wires comprise a plurality of particles oriented in a preferred magnetic flux direction of the particles.

24. A method of making a component for a wave generator armature, the method comprising:
winding one or more conductive wires around a support; and
filling a gap between at least portions of the one or more wires with one or more materials having a selected magnetic property and comprising a plurality of magnetic particles.

25. The method of claim 24, wherein filling the gap between the one or more wires with one or more materials having the selected magnetic property comprises coating at least a portion of the one or more wires with the materials having the selected magnetic property.

26. The method of claim 25, wherein filling the gap between the one or more wires with one or more materials having the selected magnetic property further comprises heating the wound one or more conductive wires.

27. The method of claim 24, wherein the one or more conductive wires are wound around the support such that the gap is a predetermined gap.

28. The method of claim 24, wherein filling the gap between the one or more wires with one or more materials having the selected magnetic property comprises vacuum filling the gap.

29. The method of claim 24, wherein the support is a bobbin.

30. The method of claim 24, wherein the support is a portion of the armature.

31. The method of claim 24, the method further comprising orienting at least some of the magnetic particles using a magnetic field.

32. The method of claim 24, wherein filling the gap between at least portions of the one or more wires with one or more materials having the selected magnetic property and comprising the plurality of magnetic particles comprises providing the one or more materials to the gap using a wicking material positioned in the gap.

33. An apparatus for converting wave motion to electrical power, wherein the system is at least partially immersed in a liquid through which the waves travel, the apparatus comprising:
a first component having an overall buoyancy relative to the liquid so as to float in the liquid;
a second component movably coupled to the first component, wherein the second component is configured to move relative to the first component in a direction of motion in response to a force from waves that is exerted on the first component; and
an electrical generator coupled to the first and second components, the electrical generator comprising at least one component molded from a resin comprising a plurality of magnetic particles.
